(19) United States
(12) Patent Application Publication
(10) Pub. No.: US 2003/0205098 A1
(43) Pub. Date: Nov. 6, 2003

(54) Apparatus and method for acquiring samples of mixed bulk materials in a flow

(76) Inventor: Sanyasi R. Kalidindi, East Brunswick, NJ (US)

Correspondence Address: KAPLAN & GILMAN , L.L.P., 900NROUTE 9 NORTH, WOODBRIDGE, NJ, 07095, US

(21) Appl. No.: 10/139,413

(22) Filed: May 6, 2002

(51) Int. Cl. G01N 1/00

(52) U.S. Cl. 73/863.81

(57) ABSTRACT

The present invention provides apparatus and method for sample acquisition from an active flow of mixed powder material being transferred from a blender. The apparatus includes a sleeve that is assembled co-axially to a discharge port of the blender and a number of sample collectors which each include a shaft with sample cavities and a tube that is rotatable around the shaft for exposing and covering the cavities. The sample collectors are alternately inserted through a bearing collar into the sleeve. The tubes are plugged at their respective outer ends to prevent accidental removal from the sleeve. The method includes inserting and opening each of the sample collectors in turn and removing the collected samples for analysis.

### FIELD OF THE INVENTION

The present invention relates to the field of sampling devices and methods for mixed bulk material, and more particularly to sampling devices and methods for mixed powder ingredients for pharmaceutical preparations.

### BACKGROUND OF THE INVENTION

In the manufacture of dosage forms, in the pharmaceutical, food and chemical industries, e.g. tablets, capsules, permeable pouches, cans etc., active and inactive ingredients are blended in a suitable blender. Such blends of materials are routinely sampled and tested for homogeneity. Blended bulk materials may be liquid, powder, or a suspension of a powder in a liquid. A proper sampling technique requires unit-dose or bulk quantity sampling to be acquired from different areas of the batch, e.g., top, middle and bottom of the blender or storage container. A unit-dose sample is defined as a quantity of mixed material that is of sufficient size to provide one dose of the active ingredient, whereas a bulk sample is defined as a sample size large enough to provide multiple doses of the active ingredient. Conventionally, samples are obtained by inserting a tubular sampling device having multiple cavities into a batch of mixed materials in the blender. However, such a sampling procedure disturbs the blend during insertion by creating localized pressure spots, thus affecting the test results. This is especially true in case of powder blends. In addition, this sampling technique requires samplers of different lengths to accommodate different size blenders or storage containers. Further, in closed flow streams of powder from a blender or container, there is no provision for compacting the samples into tablets or collecting the samples directly into gelatin capsules in order to eliminate or reduce the post-sampling error caused by transfer handling of small quantities of loose powder.

U.S. Pat. No. 5,974,900, issued on Nov. 2, 1999 to the present inventor, describes a manually operated stream sampling device and method. This device does offer the possibility of compacting the powder samples into tablets or collecting the samples directly into gelatin capsules. However, this device can be used only with open streams of material, and it is desirable to keep mixed powder materials in closed streams to avoid spreading powder dust into the ambient atmosphere.

U.S. Pat. Nos. 5,440,941, 5,337,620 and 6,339,966 each disclose a tube-and-shaft type sampling device as may be employed in the invention described and claimed herein. Each of these patents is incorporated herein in its entirety by reference.

The present invention offers the following advantages over the currently available samplers: (a) the sampler does not have to be inserted into the powder bed; (b) a closed stream of material may be sampled without exposing personnel to powder dust; (c) unit-dose samples may be obtained and processed into the form of tablets or capsules (d) multiple sample collectors are provided for efficiency; and (f) the devices are easily assembled, disassembled, operated and cleaned.

### SUMMARY OF THE INVENTION

The present invention is a sampling device and a method for obtaining samples from a falling closed stream of mixed material. The sampling device consists of a sleeve, a guide ring and one or more sample collectors.

The sleeve has holes on its top flange for being bolted to a discharge port of a blender or storage container. The bottom flange of the sleeve is formed to engage a flow skirt to convey the powder material into a drum or a bin without distributing any dust into the surrounding environment. The mixed powder flows through a sleeve formed with one or more radially aligned holes adapted for inserting a number of collectors.

The guide ring is formed with radially aligned holes on its side surface to match the holes on the cylinder's surface. Collectors are guided through these holes to retrieve samples. Each of these holes is configured to prevent the sampler shaft from rotating

Each collector has an outer tube and an inner shaft and an end piece. The outer tube and the inner shaft have corresponding openings. The inner shaft and the outer tube each have a handle so that they can be rotated individually to open and close sample-collection cavities. The end piece has a curvature that matches the inner surface of the sleeve so that the falling powder material is minimally disturbed. The end piece is larger than the hole in the sleeve to prevent unintended removal. The tube is turned to expose holes in the shaft and collect sample material, and turned back to the original position, to close the dies as described in U.S. Pat. Nos. 5,337,620 and 5,440,941, noted above. The collector shaft may be modified to accommodate empty gelatin capsules instead of holes or sample dies.

### BRIEF DESCRIPTION OF THE DRAWINGS

FIG. 1 is a side elevation view of a blender to which the sampling device of the invention is mounted.

FIG. 2 is a perspective view of a sleeve of the invention sampling device.

FIG. 3 is a top plan view of a collar adapted for being mounted around the sleeve of FIG. 1 with a plurality of collectors assembled thereto.

FIG. 3A is an enlarged segmented view similar to that in the dashed circle of FIG. 3 with the sleeve tube added for detail.

FIG. 4 is a top plan view of the collar of FIG. 3 shown in opened condition without the collectors.

FIG. 4A is a section view taken along line 4A-4A of FIG. 4.

FIG. 5 is an exploded perspective view of the collector shown in FIG. 3, comprising a tube with an end cap, a shaft, and a plurality of dies.

FIG. 6 is a diagrammatic representation of the top of the invention sleeve showing the location from which samples are obtained.

### DETAILED DESCRIPTION OF THE PREFERRED EMBODIMENT

The following description depicts the preferred embodiment as illustrated in the accompanying drawing figures. The described embodiment is provided as an example, not a limitation, of the principles of the invention.

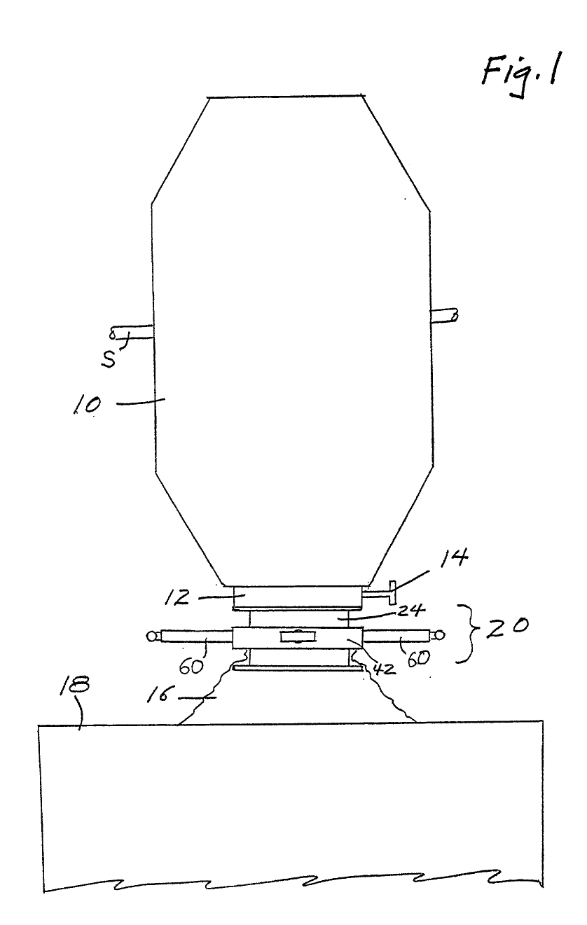

Referring now to FIG. 1, a commercial tumbling blender 10, as is known in the trade, is shown in upright orientation at the termination of the blending operation during which blender 10 is rotated, or tumbled, around shaft S to thoroughly mix powder ingredients to a homogeneous batch. The bulk material, typically a powder, consists essentially of active and inactive components to be mixed together. The speed of rotation of the blender and the length of the tumble cycle depends upon the tumbler geometry and capacity as well as the properties of the components being mixed. Blender 10 is fitted with a discharge port 12 having a discharge valve 14 by which the mixed batch may be allowed to flow out of blender 10.

The apparatus of the invention is generally depicted as sampler 20, comprising sleeve 24 and collectors 60, to be described in detail below. An upper flange of sleeve 24 is attached by means of bolts or otherwise, to discharge valve 12. A shroud 16 is mounted to encompass a lower end of sleeve 24 so that the mixed powder material is discharged from blender 10 into receptacle 18 without sending dust into the surrounding environment. The relative size of illustrated blender 10 and sampler 24 is not intended to represent actual equipment. Sampler 20 may connect to other supply apparatus, such as a duct or storage tank.

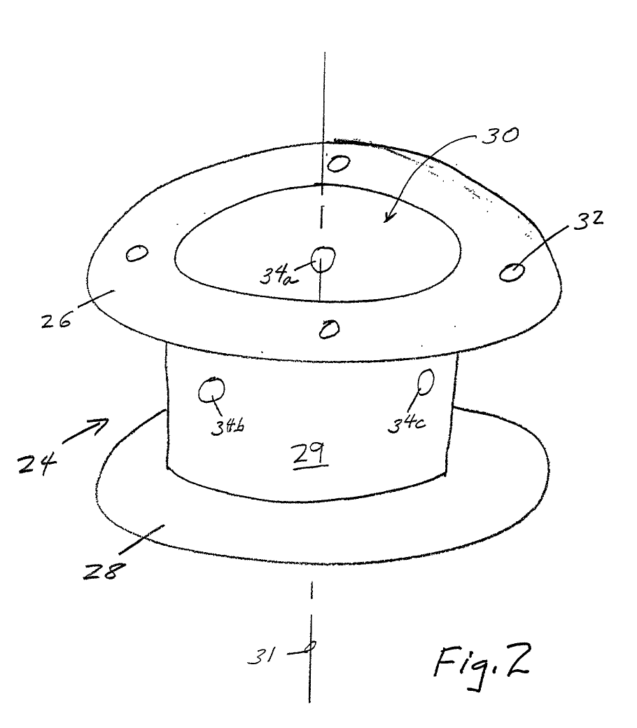

FIG. 2 shows a detail of sleeve 24 in perspective view. Sleeve 24 is formed with a circumferential wall 29, an upper flange 26 and a lower flange 28. Circumferential wall 29 defines a throat portion 30, having axis 31, through which the mixed bulk powder materials are conveyed following the blending operation. Upper flange 26 is formed with a plurality of bolt holes 32 which match with the location of a similar set of bolt holes in the under side of discharge port 12 (FIG. 1). Lower flange 28 is provided and sized to securely hold shroud 16 as described above. One or more collector holes 34 are formed through circumferential wall 29 in orientations so that each is along a radius of throat 30. As will be noted below in reference to FIG. 3, collector holes 34 are uniformly spaced around the periphery of circumferential wall 29. Sleeve 24 is preferably formed of an inert, easily cleanable material, for example stainless steel.

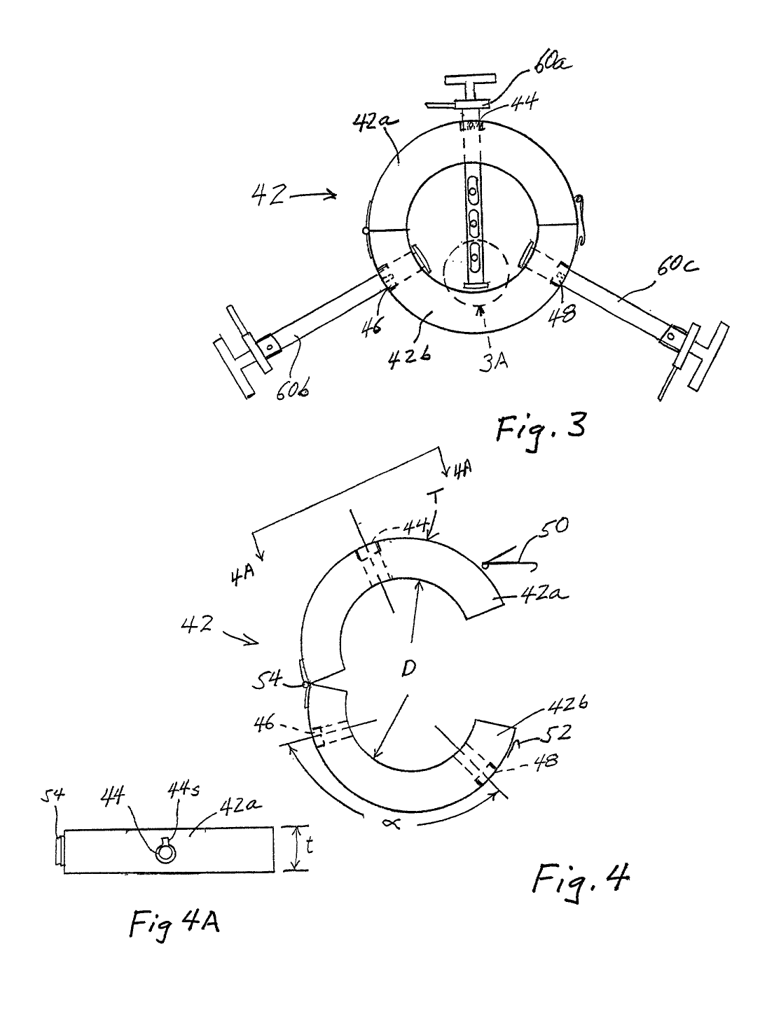

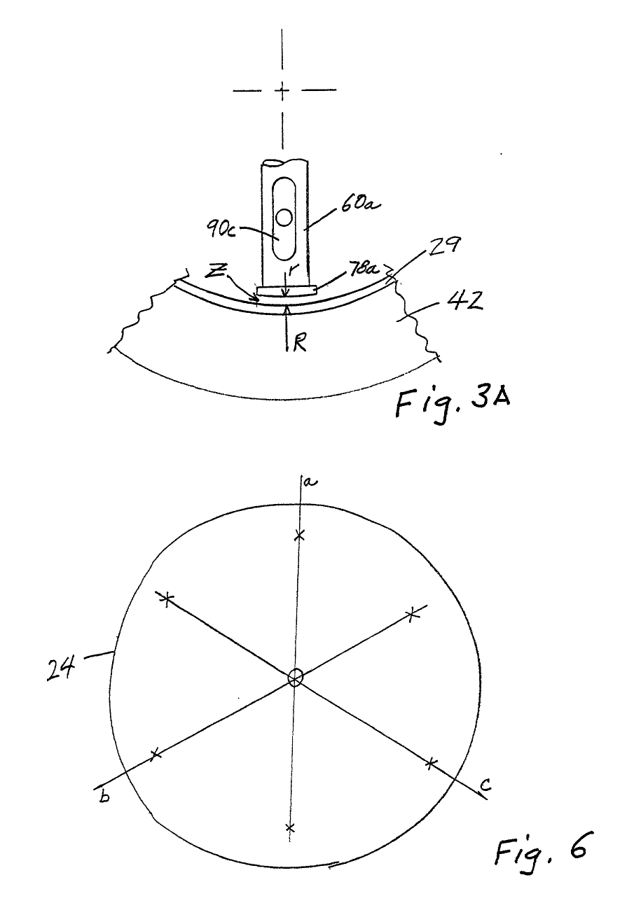

Referring now to FIGS. 3 and 4, a guide ring 42 depicted in closed and open condition, respectively. Guide ring 42 is split into two hemi-rings 42a and 42b. The two hemi-rings 42a and 42b are connected at a mutual end by hinge 54 and are closeable at an opposite end by engagement of latch 50 with hook 52. An elevation view of hemi-ring 42a is shown in FIG. 4A, as taken in the direction of line 4A-4A of FIG. 4.

The inside diameter D of guide ring 42 is sized to snugly encircle the periphery of tube 29 of sleeve 24 (see FIG. 2). Guide ring 42 has a diametral thickness of T. Guide ring 42 has a vertical thickness t, as shown in FIG. 4A. Vertical thickness t and diametral thickness T are each sufficient to receive and slidingly support collectors 60 in a guide hole 44, 46, 48, respectively. Thickness t is preferably on the order of double the outside diameter of collector 60 or greater. Diametral thickness T is preferably about 2-3 times the outside diameter of collector 60. Ring 42 is formed of a plastic resin, for example nylon, according to the preferred embodiment.

A plurality of radially aligned holes 44, 46 and 48 are formed through guide ring 42 so as to be separated from each other by substantially equal angles α, when ring 42 is closed around circumferential wall 29. In the case of the illustrated embodiment, guide holes 44, 46 and 48 are separated by angles α of 120°. Each guide hole 44, 46 and 48 is formed with an enlarged entry on the outer side of guide ring 42 and a slot 44s (shown in FIG. 4A) to accommodate a collar portion and pin of collector 60, as will be described below. Since each of collectors 60a, 60b and 60c are shown in FIG. 3 to be oriented on co-planar radii, only one of collectors 60a, 60b and 60c, for example collector 60a, can be positioned through the center of ring 42 at any one time. With collector 60a positioned across throat 30, alternate collectors 60b and 60c are retracted to reside mainly outside of ring 42 with their respective inner end caps 78a (see FIG. 6) adjacent the inner wall of ring 42.

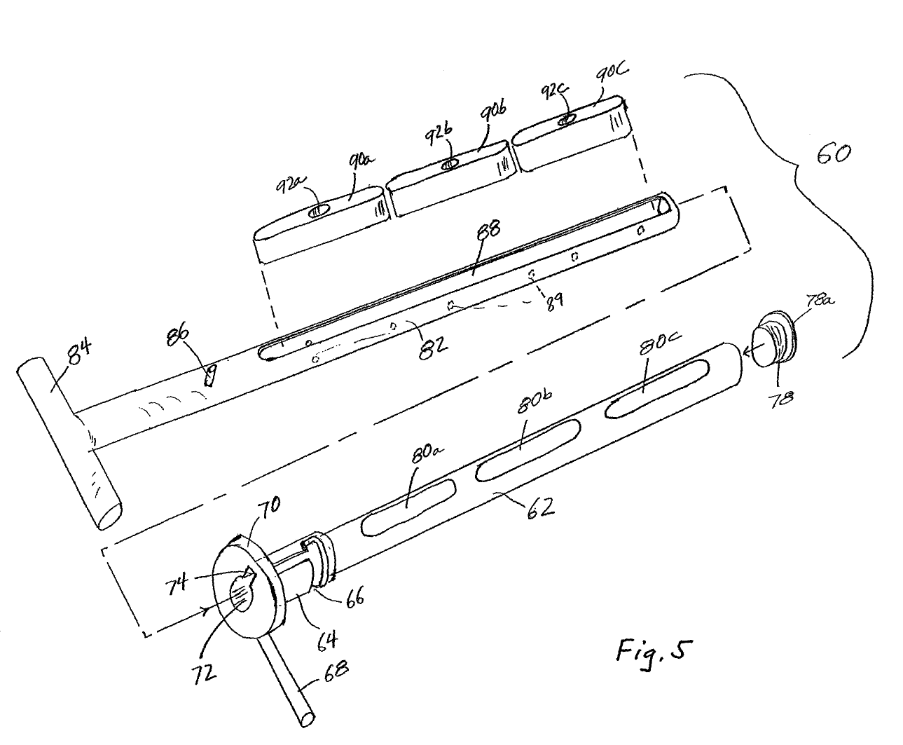

Typical collector 60 is illustrated in exploded perspective view in FIG. 5. Collector 60 is made up of tube 62, shaft 82, dies 90a, 90b and 90c, and plug 78. For purposes of description, tube 62 is assumed to have an outer end, shown on the left as illustrated FIG. 5 and an inner end, shown on the right. Outer end and inner end also refers to the radial representation of collectors 60a, 60b and 60c shown assembled to guide ring 42 in FIG. 3. Tube 62 is sized in diameter to slidingly ride in guide hole 44 and collector hole 34, with a collar 64 located adjacent the outer end of tube 62 sized to snugly engage the enlarged entry of guide hole 44. A flange 70 is formed at the outer end of tube 62 to control the depth to which tube 62, including mounted plug 78, may be inserted into sleeve 24 and serve as a connecting point for rotator 68. Rotator 68 extends radially outwardly from flange 70 and serves as a control of the angular orientation of tube 62. Tube 62 is formed with a set of apertures 80a, 80b and 80c which, when tube 62 is appropriately oriented on shaft 82, are positioned above dies 90a, 90b and 90c, respectively. As will be apparent to those skilled in the art, apertures 80 are slightly smaller than respective dies 90 so as to retain dies 90 seated in slot 88 during operation, as described below. Plug 78 is formed with a threaded end to snugly engage a matching thread within the inner end of tube 62. The outer end of plug 78 is formed with a cap 78a that has an end shape that is preferably spherical with a radius r that is parallel to the radius R of throat 30, as shown most clearly in FIG. 3A. Cap 78a is formed larger in diameter than collector holes 34 in sleeve 24. The spherical radius r of cap 78a is smaller than radius R of collar by a space Z between cap 78a and tube 29 when tube 62 is fully inserted and flange 70 contacts guide ring 42. In this configuration, cap 78a disturbs the flow of passing mixed powder material to only a minimal degree. The spherical radius r of cap 78a is similarly effective in minimizing powder flow disturbance when collector 60 is retracted outwardly as in the case of collectors 60b and 60c in FIG. 3.

Shaft 82 is sized to slidingly insert into bore 72 in tube 62 and to extend, when fully inserted, substantially the full length of tube 62. Shaft 82 is configured with a slot 88 that receives a plurality, for example 3, of dies 90. As described in the prior patents cited hereinabove, dies 90 each have a cavity 92 that has an internal volume sized to contain a selected quantity, equal to a unit dose of the powder mix. As an alternate choice of the user, dies 90 are adapted to hold a half gelatin capsule to catch the powder mix directly in the capsule, avoiding the need for transfer of the powder samples. Dies are designed to be readily replaced in shaft 82 so that a unit dose of the specific powder mix being processed may be collected. A series of pairs of holes 89 are provided through shaft 82 such that each pair of holes 89 is positioned beneath a respective one of dies 92a, 92b and 92c. By inserting a tool (not shown) through each pair of holes 89, the proximate die 92 is lifted out of shaft 82 enough so that it may be grasped by the fingers or an appropriate tool. The distance between the holes in each pair of holes 89 is greater than the distance between adjacent holes 89 in sequential pairs so that the tool cannot be inserted into holes affecting two adjacent dies. Shaft 82 is further formed with a pin 86 extending radially therefrom and positioned near a handle 84 at the outer end of shaft 82. Pin 86 is sufficiently long to extend beyond the outer diameter of collar 64 and to engage slot 44s in guide ring 42 when assembled. When dies 90 are placed within slot 88 with cavities 92 exposed and oriented to be open upwardly, shaft 82 is placed into bore 72 of tube 62 and pin 86 enters keyway 74 in flange 70. A slot 66 is formed as a “T,” with its stem parallel to the axis of tube 62 and its cross-bar circumferential thereto. After pin 86 passes through flange 70 into slot 66 in collar 64, tube 62 is rotated so that pin 86 rides along the cross-bar of slot 66 and cavities 92 are covered by the portion of tube 62 without apertures. The combined length of tube 62 and cap 78a is slightly less than the distance from the outside of guide ring 42 to the opposed inside surface of circumferential wall 29 (see FIG. 3A) when assembled.

The method of operation of the sampling apparatus of the invention is typically as follows. Guide ring 42 is placed around circumferential wall 29 of sleeve 24 and locked in place with guide holes 44 aligned with collector holes 34. The operator pushes a first tube 62 (see FIG. 3A) into sleeve 24 and threads a mating plug 78 to the inner end thereof. A shaft 82 is prepared for sample collecting by placing a number of dies 90 with cavities 92 exposed into open slot 88. Shaft 82 is then slidingly inserted into tube 62. Handle 84 is held still to keep cavities 92 facing up as rotator 68 is turned to close apertures 80. Additional collectors 60 are assembled to sampler 20 as described above. Each collector 60 is retracted so as to be positioned out of throat 30 to the extent possible. Sleeve 24 is assembled to discharge port 12 on the bottom of blender 10 by threaded fasteners or other means (not shown). Shroud 16 is connected to the bottom of sleeve 24 and its lower open end is placed into receptacle 18. Valve 14 is opened to allow mixed powdered material to flow from blender 10 through sleeve 24 and into receptacle 18. At an appropriate time in the process of transfer of the mixed bulk material from blender 10 to receptacle 18, the operator pushes a handle 84 so as to insert a selected sampler 60 across the width of throat 30. In so doing, collar 64 (see FIG. 5) enters the enlarged entry portion of guide hole 44, and pin 86, extending upward beyond collar 64, enters slot 44s. Being engaged in slot 44s, pin 86 prevents unwanted rotation of shaft 82, maintaining cavities 92 facing upward. The operator turns rotator 68 clockwise to rotate tube 62 and expose dies 90, allowing a quantity of bulk mixed material to fill each cavity 92a, 92b and 92c. Rotator 68 is turned counterclockwise to close tube 62 over cavities 92a, 92b and 92c. The operator pulls handle 84 without rotation so as to retract assembled collector 60 to the extent possible until cap 78a contacts the near-inner side of circumferential wall 29. The operator rotates handle 84 clockwise, to turn both shaft 82 and tube 62, causing dies 90a, 90b and 90c to be oriented downwardly. The operator holds handle 84 still while rotating rotator 68 further clockwise to move apertures 80a, 80b and 80c of tube 62 to expose dies 92a, 92b and 92c, while positioning a container beneath each die to transfer the sample from each die into individual containers for quality testing, as is known. Optionally, the samples obtained may be pressed into tablets prior to testing, which may be done in dies 92.

In the alternate process whereby samples of bulk mixed materials are caught in capsules that have been placed in cavities 92, shaft 82 is kept in its orientation with cavities 92 facing upward as handle 84 is pulled to retract collector 60. Rotator 68 is turned so that shaft 82 can be withdrawn from tube 62. A pair of pins of a tool (not shown) is inserted through holes 89 in tube 62 to sequentially lift each die 90 sufficiently so that the operator can remove dies 90 from slot 88 with cavity 92 and the capsule it contains remains upright. The use of a capsule half is preferred in certain circumstances, such as where the finished dosage form is a capsule or where sample compaction is not required.

To further clarify an objective of the present invention, FIG. 6 shows a diagrammatic representation of a top view of sleeve 24, with the nine positions indicated from which samples are obtained. Each of the sample positions adjacent the wall of sleeve 24 is marked with an “X” and the three sample positions at the center of sleeve 24 are marked with a single “O.”

The samples acquired above are from each edge and the center of sleeve 24 along the axis of collector 60a. Leaving collector 60a in its retracted position, the procedure described above is repeated with collector 60b and then again with collector 60c. At the end of this cycle, six samples have been collected from angularly dispersed peripheral locations and three samples from the center of sleeve 24 for comparison of product uniformity or other properties.

While the present invention is described with respect to specific embodiments thereof, it is recognized that various modifications and variations may be made without departing from the scope and spirit of the invention, which is more clearly and precisely defined by reference to the claims appended hereto.

What is claimed is:

1. Apparatus for acquiring samples of mixed bulk materials, comprising:
(a) a sleeve having an axis and a circumferential wall and configured for mounting to a discharge port so that a flow of mixed bulk material passes from the blender through the sleeve, with a hole passing through the circumferential wall thereof;
(b) a collector having a tube with a shaft residing therewithin, the collector being slidably inserted into the hole in the sleeve in substantially perpendicular alignment to the axis of the sleeve, the shaft including means for receiving and holding a sample of mixed bulk material; and
(c) the tube being configured to selectively permit the shaft to receive the bulk materials.

2. The sampling apparatus of claim 1, wherein the tube is rotatable around the shaft to alternately expose or enclose the means for receiving mixed bulk material.

3. The sampling apparatus of claim 2, wherein the means for receiving mixed bulk material comprises a cavity formed in an upwardly facing surface of the shaft.

4. The sampling apparatus of claim 3, wherein the cavity is configured for holding a capsule therein in a manner so that the capsule receives and holds a selected quantity of the mixed bulk material.

5. The sampling apparatus of claim 3, wherein the cavity is configured for receiving a unit dose of the mixed bulk material.

6. The sampling apparatus of claim 1, wherein the sleeve is formed with plural holes, each hole having a collector inserted therethrough.

7. The sampling apparatus of claim 1, further comprising a guide ring assembled to the exterior of the sleeve, the guide ring being formed with a hole aligned with the hole in the sleeve.

8. The sampling apparatus of claim 7, wherein the guide ring is removeably assembled to the exterior of the sleeve.

9. The sampling apparatus of claim 6, further comprising a guide ring assembled to the exterior of the sleeve, the guide ring being formed with a hole aligned with the hole in the sleeve.

10. The sampling apparatus of claim 9, wherein the guide ring is removeably assembled to the exterior of the sleeve.

11. A sampling apparatus for acquiring a plurality of samples of mixed bulk materials, comprising:
(a) a sleeve having an axis and a circumferential wall and configured for mounting to a discharge port so that a flow of mixed bulk material passes from the discharge port through the sleeve, the sleeve being formed with a plurality of holes passing radially through the circumferential wall thereof;
(b) a plurality of collectors, each collector having a tube with a shaft residing therewithin and the collectors being slidably respectively inserted into the holes in the sleeve, each of the shafts including a cavity for receiving and holding a sample of mixed bulk material;
(c) the tube being configured to be rotatable about the shaft so as to selectively permit the mixed bulk materials to be received by the cavity; and
(d) bearing means for maintaining the collector in substantially perpendicular alignment to the axis of the sleeve.

12. The sampling apparatus of claim 11, further comprising means for preventing the shaft from rotating as the tube is rotated.

13. The sampling apparatus of claim 11, wherein the cavity is configured for holding a capsule therein in a manner so that the capsule receives and holds a sample of the mixed bulk material.

14. The sampling apparatus of claim 11, wherein the cavity is formed in a die that is releasably mounted to the shaft.

15. The sampling apparatus of claim 11, wherein the cavity is sized to receive a quantity of the mixed powder material substantially equal to a unit dose of the mixed powder material.

16. The sampling apparatus of claim 11, wherein the bearing means is removeably assembled to the exterior of the sleeve.

17. The sampling apparatus of claim 11, wherein the tube further comprises a removeable end plug configured for minimizing disturbance of the flow of mixed bulk material.

18. The sampling apparatus of claim 17, wherein the tube end plug is configured with a substantially spherical outer surface proximate an inner surface of the sleeve.

19. The sampling apparatus of claim 17, wherein the tube end plug is configured for preventing the tube from being accidentally removed from the sleeve.

20. A method for acquiring samples of mixed bulk materials from an active bulk flow, comprising the steps of:
(a) interposing through a wall of a sleeve enclosing a flow of mixed bulk material a sample collector having at least one cavity for receiving a sample thereof;
(b) accumulating a sample quantity of the mixed bulk material in the cavity; and
(c) retracting the collector with the sample of mixed bulk material from the sleeve.

21. The method of claim 20, further comprising the steps of exposing the cavity prior to accumulating the quantity and covering the cavity subsequent to accumulating the quantity.

22. The method of claim 20, further comprising the step of removing the quantity of mixed bulk material from the sample collector.

23. The method of claim 20, wherein the sample collector is oriented in a first direction relative to the sleeve, the method further comprising interposing a second collector oriented in a second direction to the sleeve for acquiring a second sample quantity of the mixed bulk material.

24. A method for acquiring samples of mixed bulk materials from an active bulk flow, comprising the steps of:
(a) interposing through a first hole in a sleeve enclosing a flow of mixed bulk material a first sample collector having a plurality of cavities for receiving samples thereof;
(b) accumulating a sample quantity of the mixed bulk material in each of the cavities of the first collector;
(c) retracting the first collector;
(d) interposing through a second hole in the sleeve a second collector having a plurality of cavities;
(e) accumulating a sample quantity of the mixed bulk material in each of the cavities of the second collector;
(f) retracting the second collector from the sleeve.

25. The method of claim 24, wherein the sample quantity comprises substantially a unit dose of the mixed bulk material.

26. The method of claim 24, wherein the sample quantity of mixed bulk material is accumulated in a capsule.

27. The method of claim 24, wherein the first collector and the second collector each substantially intercept an axis of the sleeve.
